(19) United States
(12) Patent Application Publication
(10) Pub. No.: US 2024/0037581 A1
(43) Pub. Date: Feb. 1, 2024

(54) SERVICE OPTIMIZATION SYSTEM, SERVICE OPTIMIZATION METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventors: Tomoyuki KAGA, Mishima-shi (JP); Hideo HASEGAWA, Nagoya-shi (JP); Hiroya MATSUBAYASHI, Koto-ku (JP); Yuki ICHIOKA, Kawasaki-shi (JP); Nobuhisa OTSUKI, Toyota-shi (JP)

(73) Assignee: TOYOTA JIDOSHA KABUSHIKI KAISHA, Toyota-shi (JP)

(21) Appl. No.: 18/204,750

(22) Filed: Jun. 1, 2023

(30) Foreign Application Priority Data
Aug. 1, 2022 (JP) 2022-122894

(51) Int. Cl. G06Q 30/0202

(52) U.S. Cl. CPC G06Q 30/0202

(57) ABSTRACT

The service optimization system performs simulation using a human model modeling service utilization behavior of a customer to predict a demand for a service from real data including at least one of behavior, behavior history, and behavior schedule of the customer related to the service. Also, the service optimization system performs simulation using a service model modeling a relationship between a service parameter determining content of the service, a demand for the service, and a level of the service to determine a setting value of the service parameter for maintaining the level of the service based on the predicted demand. Then, the service optimization system acquires the real data after the service is provided using the determined setting value of the service parameter to feed back the acquired real data to an input of the simulation using the human model.

### CROSS-REFERENCE TO RELATED APPLICATION

The present application claims priority under 35 U.S.C. § 119 to Japanese Patent Application No. 2022-122894, filed Aug. 1, 2022, the contents of which application are incorporated herein by reference in their entirety.

### BACKGROUND

### Field

The present disclosure relates to a system, method, and program for optimizing a service using simulation.

### Background Art

A demand prediction device disclosed in JP2005-352728A comprises a model creation device and a prediction device. The model creation device models customer behavior using the customer's recognition of a service as the recognition including recognition of the presence of the service and recognition of the function of the service. The prediction device predicts which service is selected by the customer using a customer behavior model modeled by the model creation device. This prior art aims to improve the accuracy of the customer behavior model. However, even if the accuracy of the customer behavior model increases, it is difficult to predict the actual demand for the service.

In addition to JP2005-352728A, JP2013-106507A can be exemplified as a document showing the technical level of the technical field related to the present disclosure.

### SUMMARY

The present disclosure has been made in view of the above problem. An object of the present disclosure is to improve the accuracy of predicting demand for a service.

The present disclosure provides a service optimization system. The service optimization system of the present disclosure comprises at least one processor and a program memory communicatively coupled to the at least one processor and having a plurality of instructions stored therein. The plurality of instructions is configured to cause the at least one processor to perform the following first to third processes. The first process is a process of performing simulation using a human model modeling service utilization behavior of a customer to predict a demand for service from real data including at least one of behavior, behavior history, and behavior schedule of the customer related to the service. The second process is a process of performing simulation using a service model modeling a relationship between a service parameter determining content of the service, a demand for the service, and a level of the service to determine a setting value of the service parameter for maintaining the level of the service based on the predicted demand. The third process is a process of acquiring the real data after the service is provided using the determined setting value of the service parameter to feed back the acquired real data to an input of the simulation using the human model.

The present disclosure also provides a program that can be stored in a non-transitory computer-readable storage medium. The program of the present disclosure is configured to cause a computer to execute the first to third processes described above.

Further, the present disclosure provides a service optimization method. The service optimization method of the present disclosure includes the following first to third steps. The first step is a step of performing simulation using a human model modeling service utilization behavior of a customer to predict a demand for a service from real data including at least one of behavior, behavior history, and behavior schedule of the customer related to the service. The second step is a step of performing simulation using a service model modeling a relationship between a service parameter determining content of the service, a demand for the service, and a level of the service to determine a setting value of the service parameter for maintaining the level of the service based on the predicted demand. The third step is a step of acquiring the real data after the service is provided using the determined setting value of the service parameter to feed back the acquired real data to an input of the simulation using the human model.

According to the above-described techniques provided by the present disclosure, that is, the service optimization system, the service optimization method, and the program, the accuracy of the demand predicted by the simulation is improved by feeding back the real data of the world in which the service is actually provided to the input of the simulation using the human model. Improving the prediction accuracy of the demand leads to optimizing the setting value of the service parameter and maintaining the service level.

In the techniques provided by the present disclosure, the human model may be learned based on an error between an actual demand for the service acquired from the real data and the demand predicted by the simulation using the human model. The learning using the real data improves the accuracy of the human model.

In the techniques provided by the present disclosure, the customer may include a customer group, and the human model may be prepared for each attribute of the customer group. Preparing the human model for each attribute of the customer group leads to improving the prediction accuracy of the demand using the human model in the case of predicting the demand from the customer group.

In the techniques provided by the present disclosure, the human model may be prepared for each customer and personalized using real data acquired for each customer. Personalizing the human model for each customer leads to improving the prediction accuracy of the demand using the human model in the case of predicting the demand for each customer.

In the techniques provided by the present disclosure, the service may include a plurality of services, the service model may be prepared corresponding to each of the plurality of services, and the service utilization behavior of the customer with respect to the plurality of services may be modeled in the human model. This makes it possible to predict the demand for each service and maintain the service level for each of the plurality of services when the customer uses the plurality of services.

Further, in the techniques provided by the present disclosure, the determining of the setting value of the service parameter may comprise acquiring a service provision policy to determine from the predicted demand the setting value of the service parameter for maintaining the level of the service based on service the provision policy. This makes it possible to maintain the service level while following the service provision policy by optimizing the setting value of the service parameter based on the service provision policy.

As described above, according to the service optimization system, the service optimization method, and the program of the present disclosure, the accuracy of the demand predicted by the simulation is improved by feeding back the real data of the world in which the service is actually provided to the input of the simulation using the human model.

### BRIEF DESCRIPTION OF THE DRAWINGS

FIG. 1 is a diagram illustrating a configuration of a service optimization system according to a first embodiment of the present disclosure.

FIGS. 2A and 2B are diagrams illustrating a configuration of a human model shown in FIG. 1.

FIG. 3 is a diagram illustrating processing executed by a human simulator shown in FIG. 1.

FIG. 4 is a diagram illustrating processing executed by a service simulator.

FIG. 5 is a flow chart illustrating processing executed by a parameter setting value determiner.

FIG. 6 is a diagram illustrating a configuration of a service optimization system according to a second embodiment of the present disclosure.

FIG. 7 is a diagram illustrating processing executed by a human simulator shown in FIG. 6.

FIG. 8 is a diagram illustrating an example of a hardware configuration of the service optimization system according to each embodiment of the present disclosure.

### DETAILED DESCRIPTION

### 1. General

A service optimization system according to embodiments of the present disclosure is a system that optimizes a relationship between demand and supply of services. The service optimization system according to embodiments of the present disclosure is configured to predict a demand for a service and change a service parameter for determining a content of provision of the service based on the predicted demand. A service optimization method according to embodiments of the present disclosure is implemented by the computer processing performed in the service optimization system according to embodiments of the present disclosure.

The service optimization system according to embodiments of the present disclosure can be applied to various types of services provided in the real world. The first type of service may be a service in which the service optimization system directly controls service parameters via a network. The second type of service may be a service in which a service provider adjusts service parameters in accordance with information supplied from the service optimization system.

Specific examples of services belonging to the first type include an on-demand bus service and a ride-sharing service provided using an autonomous driving vehicle. In these services, the number of vehicles in use for each time zone, charging timing of each vehicle at a charging station, a patrol area where vehicles patrol, and the like are used as service parameters. A distribution service provided by using a delivery robot is also a specific example of services belonging to the first type. In this service, the number of delivery robots used in each time zone, the charging timing of each delivery robot at a charging station, a package collection area, and the like are used as service parameters. Furthermore, a product sales service in an online store also belongs to the first type of service. The kinds of products to be listed on the Web and the order in which they are listed are examples of service parameters in this service.

Specific examples of services belonging to the second type include a product sales service in an physical store. In this service, the kinds of products to be sold, the amount of each kind, the display location of products in the store, and the like are used as service parameters. A manned taxi service driven by a driver and a manned home delivery service in which a deliverer delivers and collects a package are also services belonging to the second type. The service parameters of the manned taxi service include, for example, the number of taxis to be dispatched and a taxi patrol area. The service parameters of the manned home delivery service include, for example, the number of vehicles and deliverers who collect packages and a package collection area.

In any service, the price of the service to be provided and the price of a product to be provided in the service are examples of service parameters. Therefore, the dynamic pricing is included in the means for optimizing the relationship between demand and supply of services that can be adopted by the service optimization system according to embodiments of the present disclosure.

The service optimization system according to embodiments of the present disclosure has a function of predicting a demand for a service. Various methods are known as a method of predicting the demand for the service. For example, there are a method of predicting demand by a statistical method using past result data, and a method of predicting demand by analysis of big data by machine learning. However, instead of using such a conventional method as it is, the service optimization system according to embodiments of the present disclosure uses a method of predicting demand from the behavior of customers to whom the service is to be provided.

Specifically, the service optimization system according to embodiments of the present disclosure predicts the demand for the service by simulation using a human model. In the human model, the behavior of customers using the service is modeled. Since customer behavior results in the demand for the service and customer behavior results from the provision of the service, customer behavior leading to the demand for the service can be modeled. However, the modeled behavior is a routine behavior, and a behavior other than the routine, which leads to an impulse purchase, is excluded from the modeling. A machine learning model can be used for the human model. The type of the machine learning model is not limited. For example, the human model may be a linear regression model, a neural network model, or a deep learning model.

In the simulation using the human model, real data obtained in the real world is used. However, the real data to be used is data on the current behavior, the past behavior history, and the future behavior schedule of customers to whom the service is to be provided. However, among such real data, data input to the human model is limited to data related to the service whose demand is to be predicted. Such data can be used to accurately predict the demand for the service from customers.

In addition, the service optimization system according to embodiments of the present disclosure considers the service level when determining the value of the service parameter from the predicted demand. This is because there are a plurality of service parameter setting values that can satisfy the demand, and the service level changes depending on the service parameter setting value. Taking the ride-sharing service as an example, if six customers are expected to use the service, the service level differs depending on whether one vehicle with six seats is supplied or two vehicles with four seats are supplied. In the former case, the waiting time for customers to wait for the arrival of the vehicle is longer than in the latter case, and the degree of congestion in the vehicle is also higher.

In practice, a single service often has a plurality of service parameters. In such a case, the service level is determined by a combination of setting values of the plurality of service parameters. Therefore, the service optimization system according to embodiments of the present disclosure determines the setting value of the service parameter for maintaining the service level at a predetermined threshold level or more from the predicted demand by simulation using the service model. In the service model, a relationship between a service parameter, a demand for a service, and a service level is modeled. A machine learning model can be used as the service model. The type of the machine learning model is not limited.

Hereinafter, the service optimization system according to embodiments of the present disclosure will be described in detail with reference to the drawings.

### 2. First Embodiment

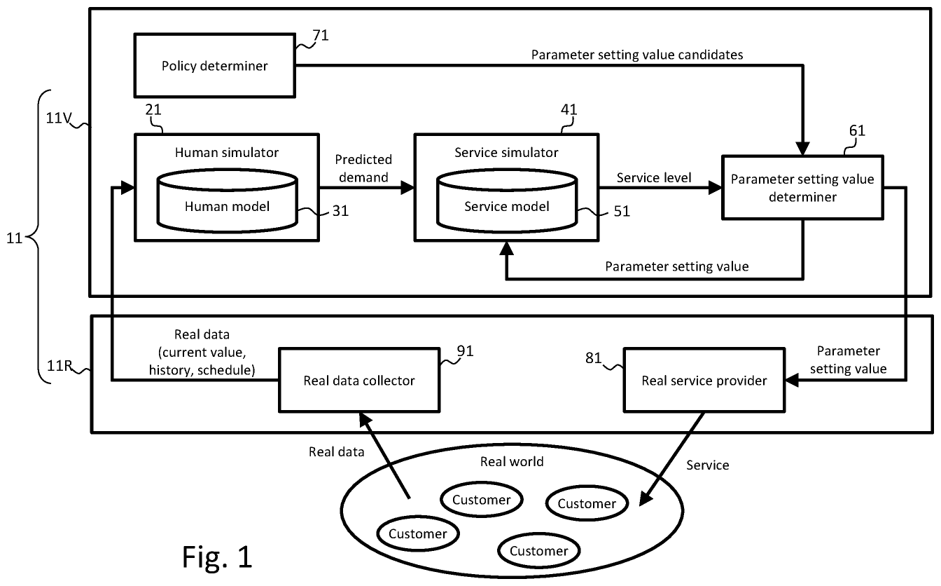

The service optimization system according to the first embodiment of the present disclosure is a system for a single service. FIG. 1 is a diagram illustrating a configuration of the service optimization system 11 according to the first embodiment of the present disclosure.

As shown in FIG. 1, the service optimization system 11 includes a virtual part 11V provided in a virtual world and a real part 11R provided in a real world. The virtual world in which the virtual part 11V is provided is a world realized by a computer that physically configures the service optimization system 11. The virtual part 11V may be provided on the cloud and may be connected to the real part 11R through a network including the Internet.

The virtual part 11V includes a human simulator 21, a service simulator 41, a parameter setting value determiner 61, and a policy determiner 71. These devices 21, 41, 61, and 71 are virtual devices and are implemented by a program executable by a computer. There is no limitation on the hardware configuration of the computer on which the program for implementing the virtual part 11V is executed.

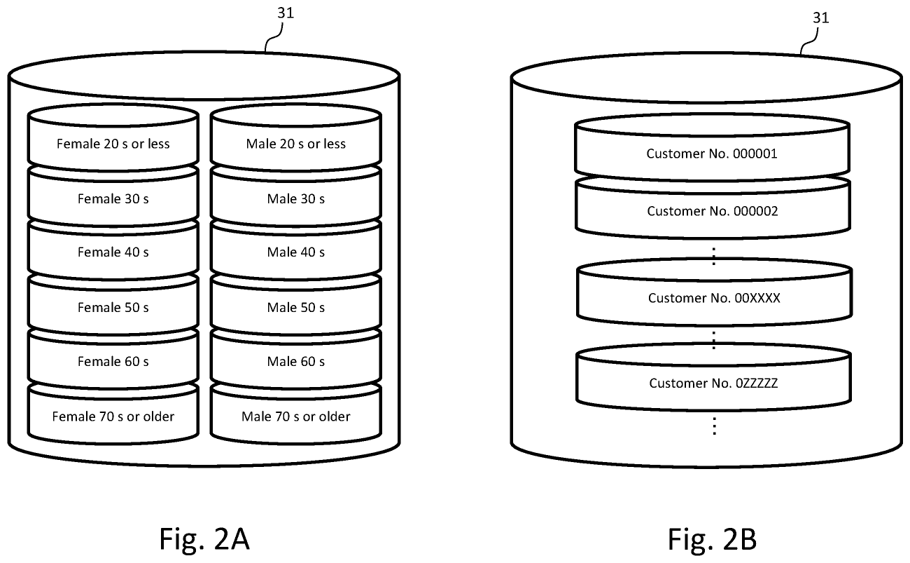

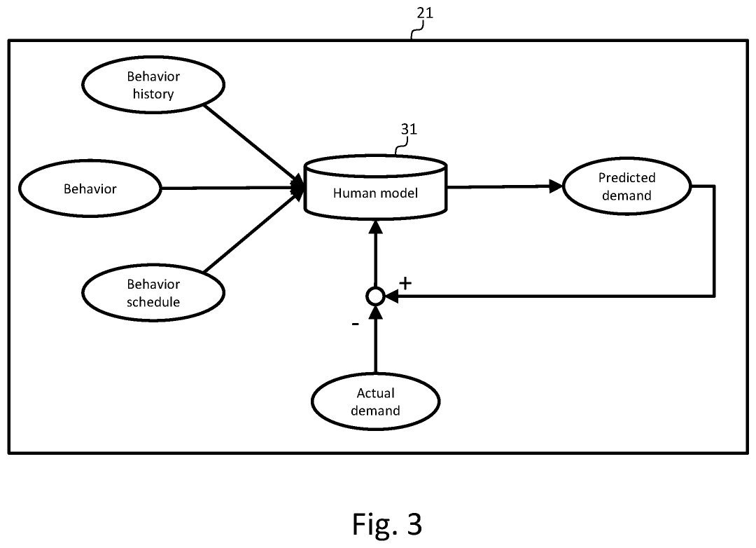

The human simulator 21 is configured to predict the demand for the service using a human model 31. The details of the human simulator 21 will be described below with reference to FIGS. 2A and 2B and FIG. 3.

In the human model 31, the behavior of customers in using the service targeted by the service optimization system 11 is modeled. The configuration of the human model 31 will be described with reference to FIG. 2A. In the configuration shown in FIG. 2A, customers are grouped by attributes, and a human model is prepared for each group. In other words, the human model 31 is represented as a set of human models prepared for each customer group. Examples of customer attributes may include gender and age. According to the configuration shown in FIG. 2A, for example, a 45-year-old female and a 55-year-old male belong to different groups, and their demands are predicted using different human models. On the other hand, a 32-year-old female and a 38-year-old female belong to the same group, and their demands are predicted using the same human model. Other examples of customer attributes may include occupation and living area.

Another configuration of the human model 31 is shown in FIG. 2B. In the configuration shown in FIG. 2B, a human model is prepared for each customer. For example, if there are N customers of the service targeted by the service optimization system 11, a total of N human models are prepared. That is, the human model 31 is represented as a set of human models prepared for each customer. The human model prepared for each customer is personalized using real data acquired for each customer.

Note that the amount of real data required to personalize a human model for each customer is enormous. Therefore, every time a new customer appears, it is not easy to prepare a human model of that customer. Therefore, first, a human model prepared for each attribute of the customer group may be used as shown in FIG. 2A, and a human model for each customer shown in FIG. 2B may be used for customers for whom real data sufficient for personalization is available.

FIG. 3 is a diagram illustrating processing executed by the human simulator 21. The human simulator 21 inputs real data on the customer's current behavior, past behavior history, and future behavior schedule to the human model 31. The demand for the service predicted from the inputted real data is outputted from the human model 31. The availability of real data about past, present, and future activities leads to accurate prediction of the demand for the service from the customer. However, it is not necessary that all of these three types of real data are prepared, and it is sufficient that at least a part thereof is input to the human model 31.

The human simulator 21 stores the predicted demand for the service output from the human model 31 in storage. In addition, the human simulator 21 acquires data related to actual demand for the service in the real world. The higher the accuracy of the human model 31, the smaller the error of the predicted demand with respect to the actual demand. The human simulator 21 feeds back the error of the predicted demand with respect to the actual demand to the human model 31 and learns the parameters of the human model 31. The learning of the human model 31 may be performed by batch processing or may be performed in parallel with the simulation.

Referring back to FIG. 1, the description of the virtual part 11V will be continued. The human simulator 21 transmits the predicted demand for the service output from the human model 31 to the service simulator 41.

The service simulator 41 is configured to calculate the level of service level that can be achieved by the currently set service parameters for the predicted demand for the service. The service simulator 41 uses a service model 51 to calculate the service level.

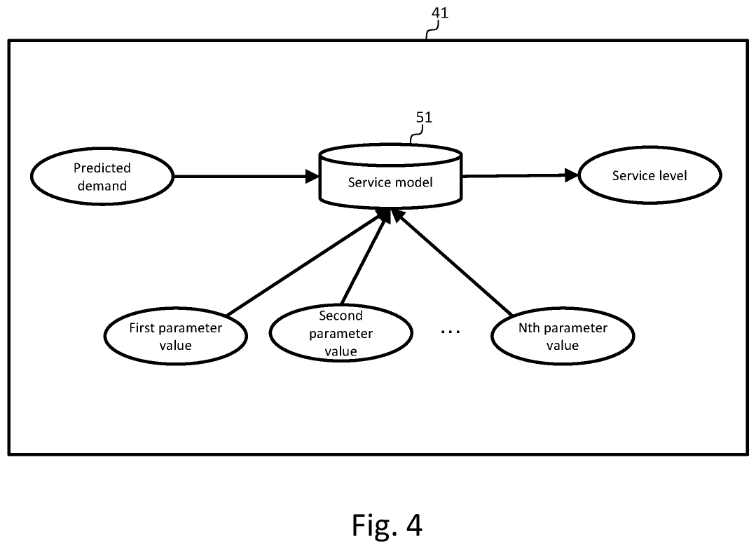

FIG. 4 is a diagram illustrating processing executed by the service simulator 41. The service simulator 41 inputs the predicted demand for the service calculated by the human model 31 to the service model 51. Further, the service simulator 41 inputs the current setting values of the service parameters to the service model 51. There is a plurality of service parameters that need to be set to provide one service. The service simulator 41 inputs the current setting values of all the service parameters to the service model 51. For example, when the service targeted by the service optimization system 11 is a ride-sharing service, setting values such as the number of vehicles in use, the charging timing of each vehicle in a charging station, and a patrol area where vehicles patrol are input to the service model 51. The service level calculated from the input predicted demand for the service and the current setting value of each service parameter is output from the service model 51.

Referring back to FIG. 1, the description of the virtual part 11V will be continued. The service simulator 41 transmits the service level output from the service model 51 to the parameter setting value determiner 61.

The parameter setting value determiner 61 is configured to refer to the service level input from the service simulator 41 and determine a setting value of the service parameter so as to maintain the level of the service provided to the customer at a predetermined threshold level or higher. Specifically, when the input service level does not reach a predetermined threshold level or more, the parameter setting value determiner 61 changes the setting value of the service parameter. When the changed setting value of the service parameter is input to the service model 51, the service level output from the service model 51 also changes.

The parameter setting value determiner 61 receives setting value candidates of the service parameter from the policy determiner 71. The policy determiner 71 receives an input of a service provision policy from the service provider. When the service provider has a service provision policy, the value that each service parameter can take is restricted by the service provision policy. The policy determiner 71 reflects the service provision policy determined by the service provider on the setting value candidates of the service parameter. For example, when the service parameters are the number of vehicles in use and the operation time in the ride-sharing service, the setting value candidates of each service parameter may be determined such that the operation time per vehicle is reduced as the number of vehicles in use is increased.

The parameter setting value determiner 61 determines the setting value of the service parameter from the setting value candidates of the service parameter input from the policy determiner 71. When the setting value candidates of the service parameter are indicated by a range, the setting value of the service parameter is determined within the range. When the relationship between the setting values of the plurality of service parameters is defined in the setting value candidate, the setting value of the service parameter is determined in accordance with the defined relationship.

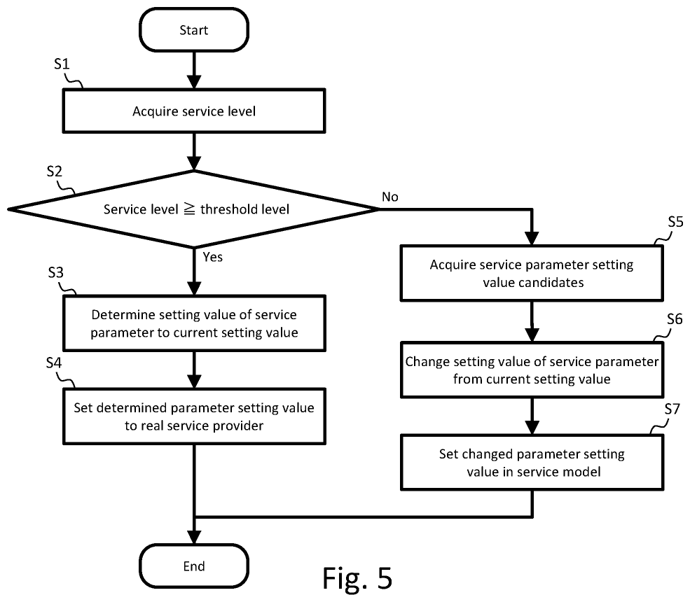

The above-described processing performed by the parameter setting determiner 61 can be represented by a flowchart as shown in FIG. 5. First, in step S1, the service level under the current setting value of the service parameter is acquired from the service simulator 41. In step S2, it is determined whether the service level acquired in step S1 is greater than or equal to a predetermined threshold level.

The positive result of the determination in step S2 means that the current setting value of the service parameter allows the service to be provided to the customer with the level higher than the predetermined level. In this case, the processing flow proceeds to step S3. In step S3, the current setting value is determined to be used as the setting value of the service parameter. Then, in step S4, the setting value of the service parameter determined in step S3 is set to a real service provider 81 described later.

On the other hand, the negative result of the determination in step S2 means that the current setting value of the service parameter does not allow the service to be provided to the customer with the level higher than the predetermined level. In this case, the processing flow proceeds to step S5. In step S5, the setting value candidates of the service parameter determined in accordance with the service provision policy are acquired from the policy determiner 71. In step S6, the setting value of the service parameter is changed from the current setting value to anyone among the setting value candidates acquired in step S5. In step S7, the setting value of the service parameter changed in step S6 is set to the service model 51.

Referring back to FIG. 1, the description of the virtual part 11V will be continued. In the virtual part 11V, as described above, the setting value of the service parameter for maintaining the service level at the predetermined level or more is determined from the demand predicted from the real data based on the service provision policy. The setting value of the service parameter determined in the virtual part 11V is transmitted to the real part 11R.

The real part 11R includes a real service provider 81 and a real data collector 91. The real service provider 81 is a device that provides service to the customer in the real world. The configuration and function of the real service provider 81 may vary depending on the content of the service to be provided.

For example, in the case of a ride-sharing service provided using an autonomous driving vehicle, the autonomous driving vehicle may be the real service provider 81. In the case of a distribution service provided using a delivery robot, the delivery robot may be the real service provider 81. In these services belonging to the first type, the setting value of the service parameter can be directly set in the automatic driving vehicle or the delivery robot.

In addition, in the case of a product sales service in a physical store, a computer which is disposed in the physical store and displays the setting value of the service parameter on a display may be the real service provider 81. In the case of a manned home delivery service, a computer that is installed in each home delivery vehicle and instructs a deliverer to the setting value of the service parameter may be the real service provider 81. In these services belonging to the second type, the setting value of the service parameter is used as an instruction value for the service provider or the employee.

The real data collector 91 is configured to collect real data on the behavior of the customer in the real world where services are provided to the customer. The real data collected by the real data collector 91 is real data related to the customer's current behavior, past behavior history, and future behavior schedule. The real data collector 91 inputs the collected real data to the human model 31. The configuration and function of the real data collector 91 depends on the content of the service that affects the behavior.

For example, in the case where the service provided to the customer is a ride-sharing service provided using an autonomous driving vehicle, the current position of the customer from the nearest station may be collected as real data on the behavior. In this case, the GPS system included in the portable terminal of the customer may be the real data collector 91. Also, the customer's payment record for the transportation service may be collected as real data on the past behavior history. In this case, the payment system may be the real data collector 91. Additionally, the customer's schedule may be collected as real data on the future behavior schedule. In this case, a web calendar in which the customer's schedule is registered may be the real data collector 91.

If the service provided to the customer is a product sales service in a physical store, the opening and closing of the refrigerator at the customer's home may be collected as real data on the customer's current behavior. In this case, the sensor attached to the refrigerator may be the real data collector 91. In addition, a receipt issued at the time of accounting may be collected as real data on the past behavior history. In this case, the POS system may be the real data collector 91. Additionally, menu downloads from the Internet may be collected as real data on the future activity schedule. In this case, the server that has received the download operation may be the real data collector 91.

In the real part 11R, as described above, the service is provided to the real world in accordance with the setting value of the service parameter determined in the virtual part 11V. The real part 11R collects real data reflecting the result of providing the service and transmits the collected real data to the virtual part 11V. According to the service optimization system 11, by repeating the above-described processing, the prediction accuracy of the demand for the service is improved, and the setting value of the service parameter is optimized to maintain the service at a high level.

Although the service optimization system 11 according to the present embodiment includes the virtual part 11V and the real part 11R, only the virtual part 11V may be defined as the service optimization system. That is, the real part 11R does not necessarily form a part of the service optimization system. The virtual part 11V and anyone of the real service provider 81 and the real data collector 91 may constitute the service optimization system.

### 3. Second Embodiment

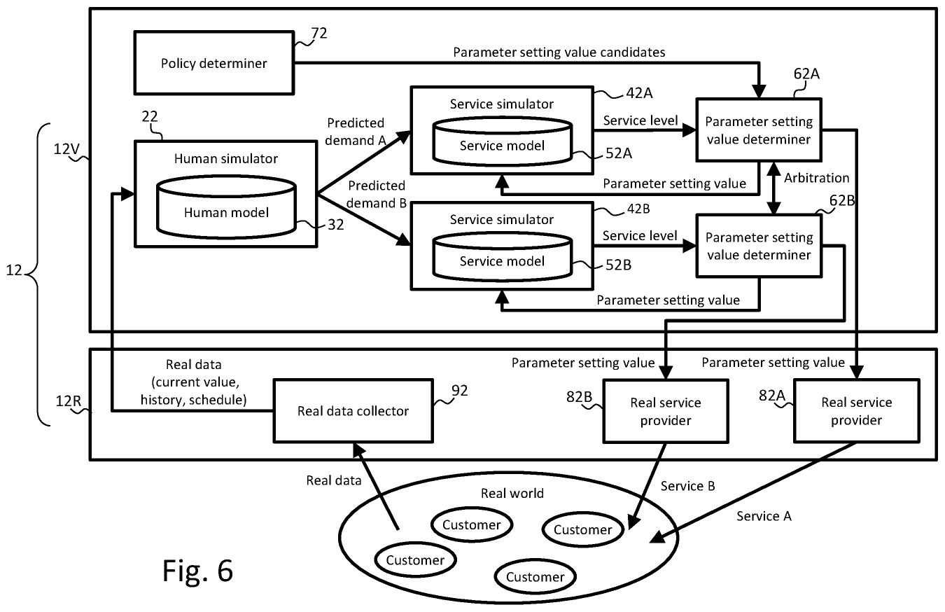

The service optimization system according to the second embodiment of the present disclosure is a system for a plurality of services. For the sake of simplicity, it is assumed that services targeted for optimization by the service optimization system are two services, service A and service B. FIG. 6 is a diagram illustrating a configuration of the service optimization system 12 according to the second embodiment of the present disclosure.

As shown in FIG. 6, the service optimization system 12 includes a virtual part 12V provided in the virtual world and a real part 12R provided in the real world. However, as described in the first embodiment, only the virtual part 12V may be defined as the service optimization system. That is, the real part 12R does not necessarily form a part of the service optimization system.

The virtual part 12V includes a human simulator 22, service simulators 42A and 42B, parameter setting value determiners 62A and 62B, and a policy determiner 72. These devices 22, 42A, 42B, 62A, 62B, and 72 are virtual devices, and are implemented by a program executable by a computer. There is no limitation on the hardware configuration of the computer on which the program for implementing the virtual part 12V is executed.

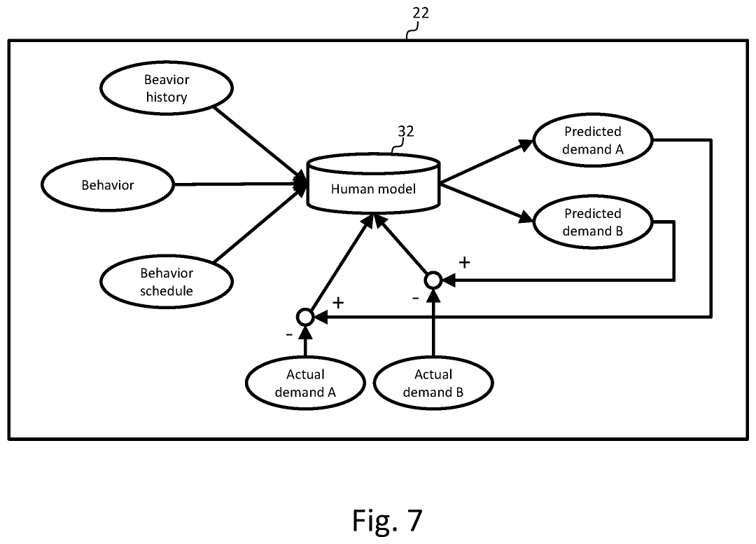

The human simulator 22 is configured to predict the demand for services using the human model 32. As in the first embodiment, the human model 32 may be a set of human models prepared for each customer group grouped according to the attribute of the customer. Alternatively, the human model 32 may be a set of human models for each customer personalized using real data acquired for each customer. Hereinafter, the human simulator 22 will be described in detail with reference to FIG. 7.

FIG. 7 is a diagram illustrating processing executed by the human simulator 22. The human simulator 22 inputs real data on the customer's current behavior, past behavior history, and future behavior schedule into the human model 32. In the human model 32, utilization behavior of the customer with respect to the service A and the service B is modeled. The relationship between the service A and the service B related to the utilization behavior of the customer is reflected in the human model 32. The demand for the service A (predicted demand A) and the demand for the service B (predicted demand B) predicted from the input real data are output from the human model 32.

The human simulator 22 stores the predicted demand A and the predicted demand B output from the human model 32 in storage. In addition, the human simulator 22 acquires data related to the actual demand for the service A (actual demand A) and the actual demand for the service B (actual demand B) in the real world. As the accuracy of the human model 32 is higher, the error of the predicted demand A with respect to the actual demand A is smaller, and the error of the predicted demand B with respect to the actual demand B is also smaller. The human simulator 22 feeds back the error of the predicted demand A with respect to the real demand A and the error of the predicted demand B with respect to the actual demand B to the human model 32 to learn the parameters of the human model 32. Note that the learning of the human model 32 may be performed by batch processing or may be performed in parallel with the simulation.

Referring back to FIG. 6, the description of the virtual part 12V will be continued. The human simulator 22 transmits the predicted demands for the services output from the human model 32 to the service simulators 42A and 42B. The service simulators 42A and 42B are provided independently for each service.

The service simulator 42A is configured to calculate the service level of the service A that can be achieved by the currently set service parameter for the predicted demand A. The service simulator 42A uses the service model 52A to calculate the service level. In the service model 52A, a relationship between a service parameter of the service A, a demand for the service A, and a service level of the service A is modeled. The service simulator 42A transmits the service level output from the service model 52A to the parameter setting value determiner 62A.

In addition, the service simulator 42B is configured to calculate the service level of the service B that can be achieved by the currently set service parameter for the predicted demand B. The service simulator 42B uses the service model 52B to calculate the service level. In the service model 52B, a relationship between a service parameter of the service B, a demand for the service B, and a service level of the service B is modeled. The service simulator 42B transmits the service level output from the service model 52B to the parameter setting value determiner 62B.

The parameter setting value determiner 62A changes the setting value of the service parameter of the service A when the service level input from the service simulator 42A does not reach a predetermined level or more. When the changed setting value of the service parameter is input to the service model 52A, the service level output from the service model 52A also changes. Similarly, the parameter setting value determiner 62B changes the setting value of the service parameter of the service B when the service level input from the service simulator 42B does not reach a predetermined level or more. When the changed setting value of the service parameter is input to the service model 52B, the service level output from the service model 52B also changes.

The parameter setting value determiners 62A and 62B receive service parameter setting value candidates from the policy determiner 72. The policy determiner 72 receives an input of the provision policy of each of the services A and B from the service provider, and reflects the provision policy of each of the services A and B determined by the service provider on the setting value candidate of the service parameter of each of the services A and B. The parameter setting value determiner 62A determines the setting value of the service parameter of the service A from among the setting value candidates of the service parameter of the service A. The parameter setting value determiner 62B determines the setting value of the service parameter of the service B from among the setting value candidates of the service parameter of the service B.

The parameter setting value determiners 62A and 62B function to arbitrate the setting values of the service parameters between them. This function is effective, for example, when there is an overlap in the resources used between the service A and the service B and the resources are limited. As a specific example, it is assumed that the service A is an on-demand bus service using an automatic driving vehicle, the service B is a logistics service using a delivery robot, and the automatic driving vehicle and the delivery robot share a charging station. Since the automatic driving vehicle and the delivery robot cannot use one charging station at the same time, the optimum charging timing for the service A and the optimum charging timing for the service B are not necessarily compatible with each other. In such a case, the parameter setting value determiners 62A and 62B shift the setting values of the service parameters from the optimum values by their arbitration functions. In this way, the entire service is optimized.

In the virtual part 12V, the setting values of the service parameters of the services A and B whose service levels are maintained at a predetermined level or higher are determined from the demands predicted from real data based on the provision policy of the services. The setting values of the service parameters of the services A and B determined in the virtual part 12V are transmitted to the real part 12R.

The real part 12R includes real service providers 82A and 82B and a real data collector 92. The real service provider 82A is a device that provides the service A to customers in the real world. The real service provider 82B is a device that provides the service B to customers in the real world. The specific examples of the real service provider 81 introduced in the first embodiment also apply to the real service providers 82A and 82B.

The real data collector 92 is configured to collect real data on the customer's behavior in the real world where customers are provided with services A, B. The real data collected by the real data collector 92 is real data on the customer's current behavior, past behavior history, and future behavior schedule. The real data collected by the real data collector 92 is real data related to at least one of the service A and the service B. The real data collector 92 inputs the collected real data to the human model 32.

In the real part 12R, the services A and B are provided to the real world in accordance with the setting values of the service parameters determined in the virtual part 12V. The real part 11R collects real data reflecting the results of providing the services A and B, and transmits the collected real data to the virtual part 12V. According to the service optimization system 12, by repeating the above-described processing, the prediction accuracy of the demand for each of the services A and B is improved, and the setting value of the service parameter of each of the services A and B is optimized to maintain the service level of each of the services A and B at a high level.

### 4. Hardware Configuration

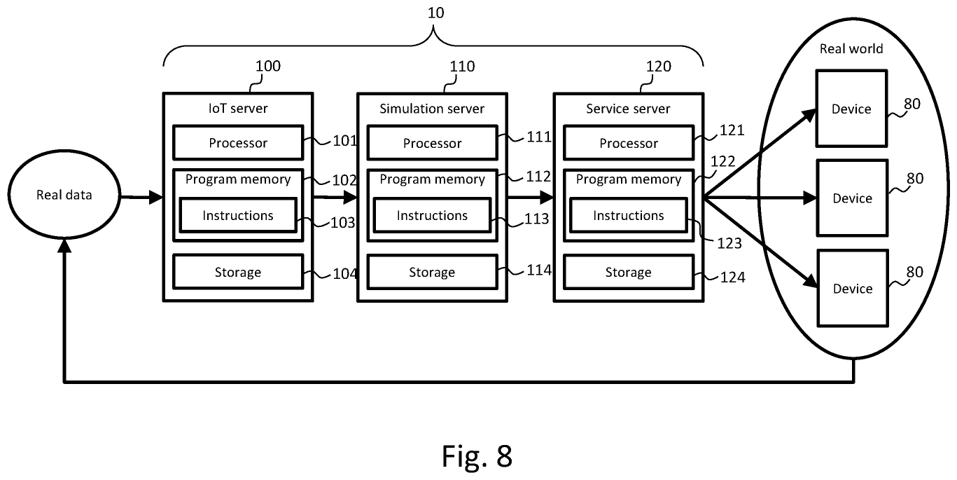

Finally, a hardware configuration of the service optimization system will be described. FIG. 8 is a diagram illustrating an example of the hardware configuration of the service optimization system. The service optimization system 10 illustrated in FIG. 8 corresponds to both the service optimization system 11 according to the first embodiment and the service optimization system 12 according to the second embodiment.

The service optimization system 10 illustrated in FIG. 8 includes an IoT server 100, a simulation server 110, and a service server 120. The IoT server 100 corresponds to an input interface of the virtual parts 11V and 12V of the service optimization systems 11 and 12. The service server 120 is a server that transmits setting values of service parameters to various devices (corresponding to real service providers) in the real world, and corresponds to an interface for outputting the virtual parts 11V and 12V. The simulation server 110 corresponds to the virtual parts 11V and 12V themselves.

Each server 100, 110, 120 comprises a processor 101, 111, 121, a program memory 102, 112, 122, and a storage 104, 114, 124. The program memory 102, 112, 122 and the storage 104, 114, 124 are coupled to the processor 101, 111, 121. A plurality of instructions 103, 113, 123 are stored in the program memory 102, 112, 122. When the instructions 103, 113, and 123 are executed by the processors 101, 111, and 121, each function of the service optimization system 10 is realized.

The hardware configuration of the service optimization system 10 illustrated in FIG. 8 is merely an example of a hardware configuration applicable to the service optimization systems 11 and 12. For example, the above three servers 100, 110, 120 may be integrated into one server, or may be distributed to more servers.

What is claimed is:

1. A service optimization system comprising:
at least one processor; and
a program memory communicatively coupled to the at least one processor, the program memory storing a plurality of executable instructions configured to cause the at least one processor to:
perform simulation using a human model modeling service utilization behavior of a customer to predict a demand for a service from real data including at least one of behavior, behavior history, and behavior schedule of the customer related to the service;
perform simulation using a service model modeling a relationship between a service parameter determining content of the service, a demand for the service, and a level of the service to determine a setting value of the service parameter for maintaining the level of the service based on the predicted demand; and
acquire the real data after the service is provided using the determined setting value of the service parameter to feed back the acquired real data to an input of the simulation using the human model.

2. The service optimization system according to claim 1, wherein the plurality of executable instructions is configured to further cause the at least one processor to learn the human model based on an error between an actual demand for the service acquired from the real data and the predicted demand.

3. The service optimization system according to claim 1, wherein the customer includes a customer group, and the human model is prepared for each attribute of the customer group.

4. The service optimization system according to claim 1, wherein the human model is prepared for each customer and personalized by using real data acquired for each customer.

5. The service optimization system according to claim 1, wherein the service includes a plurality of services, the service model is prepared corresponding to each of the plurality of services, and the service utilization behavior of the customer with respect to the plurality of services is modeled in the human model.

6. The service optimization system according to claim 1, wherein the determining the setting value of the service parameter comprises acquiring a service provision policy to determine the setting value of the service parameter based on the service provision policy.

7. A service optimization method comprising:
performing simulation using a human model modeling service utilization behavior of a customer to predict a demand for a service from real data including at least one of behavior, behavior history, and behavior schedule of the customer related to the service;
performing simulation using a service model modeling a relationship between a service parameter determining content of the service, a demand for the service, and a level of the service to determine a setting value of the service parameter for maintaining the level of the service based on the predicted demand; and
acquiring the real data after the service is provided using the determined setting value of the service parameter to feed back the acquired real data to an input of the simulation using the human model.

8. The service optimization method according to claim 7, further comprising learning the human model based on an error between an actual demand for the service acquired from the real data and the predicted demand.

9. The service optimization method according to claim 7, wherein the customer includes a customer group, and the human model is prepared for each attribute of the customer group.

10. The service optimization method according to claim 7, wherein the human model is prepared for each customer and personalized by using real data acquired for each customer.

11. The service optimization method according to claim 7, wherein the service includes a plurality of services, the service model is prepared corresponding to each of the plurality of services, and the service utilization behavior of the customer with respect to the plurality of services is modeled in the human model.

12. The service optimization method according to claim 7, wherein the determining the setting value of the service parameter comprises acquiring a service provision policy to determine the setting value of the service parameter based on the service provision policy.

13. A non-transitory computer-readable storage medium storing a program comprising a plurality of executable instructions configured to cause at least one processor to:
perform simulation using a human model modeling service utilization behavior of a customer to predict a demand for a service from real data including at least one of behavior, behavior history, and behavior schedule of the customer related to the service;
perform simulation using a service model modeling a relationship between a service parameter determining content of the service, a demand for the service, and a level of the service to determine a setting value of the service parameter for maintaining the level of the service based on the predicted demand; and
acquire the real data after the service is provided using the determined setting value of the service parameter to feed back the acquired real data to an input of the simulation using the human model.

14. The non-transitory computer-readable storage medium according to claim 13, wherein the plurality of executable instructions is configured to further cause the at least one processor to learn the human model based on an error between an actual demand for the service acquired from the real data and the predicted demand.

15. The non-transitory computer-readable storage medium according to claim 13, wherein the customer includes a customer group, and the human model is prepared for each attribute of the customer group.

16. The non-transitory computer-readable storage medium according to claim 13, wherein the human model is prepared for each customer and personalized by using real data acquired for each customer.

17. The non-transitory computer-readable storage medium according to claim 13, wherein the service includes a plurality of services, the service model is prepared corresponding to each of the plurality of services, and the service utilization behavior of the customer with respect to the plurality of services is modeled in the human model.

18. The non-transitory computer-readable storage medium according to claim 13, wherein the determining the setting value of the service parameter comprises acquiring a service provision policy to determine the setting value of the service parameter based on the service provision policy.
